(19) United States
(12) Patent Application Publication
(10) Pub. No.: US 2005/0110280 A1
(43) Pub. Date: May 26, 2005

(54) Slide secure

(76) Inventor: Kenneth Wayne Guy, Ukiah, CA (US)

Correspondence Address: Kenneth Guy, 875 South OAK Street #3, Ukiah, CA, 95482, US

(21) Appl. No.: 10/409,492

(22) Filed: Nov. 24, 2003

(51) Int. Cl. E05C 19/18

(52) U.S. Cl. 292/259 R

(57) ABSTRACT

Slide-Secure is an invention designed to prevent an intruder from entering from the sliding glass door. The idea is two locking pieces of hard plastic in the door tract and frame of the sliding glass door way properly installed will prevent the intrusion of a outside entry going trough the sliding glass door way. This invention is designed for both upstairs apartment complexes with decks where the sliding glass doors are opposite not like the house sliding glass door systems. “Side-Secure” will also work on the non-commercial house residence sliding glass doors as well.

### BACKGROUND OF INVENTION

I thought of slide secure one day while looking at ways to look my sliding glass door better to keep out a robber. I had been using a sawed broom handle and sawed board. Then i used two pieces of board interlocked in bracing the frame and the door, then tried two pieces of plastic pipes inter screwed and cut to specifications fitting in door channel and frame, that's when I came up with “Slide-secure”. I then continued to improve on it and then came up a final product. This eliminates the door broom handle and the cut of board in the sliding door.

### RELATED PRIOR ART: BACKGROUND ART

Patent Number: U.S. Pat. No. 4,630,853=Lock for sliding doors
Patent Number: U.S. Pat. No. 6,474,707 b1=Sliding door locking and venting Device.
   These inventions were different in the ways they locked the door and secured it. One used pipe and one used brace with two lock screws. Mine is different in that mine goes in me frame and channel of the doorway and the locking device is secure in place. The others did a service of the top locking device and the other one did an open locking space.

### SUMMARY OF THE INVENTION

“Slide-Secure” solves the problem of preventing an unwanted intrusion by the means of not allowing the door to be lifted up from the outside. The inter-locking “Slide-Secure” locks the door down and doesn't allow it to slide. It does this by fitting the channel of the frame and on the grove of the threshold, and then it also holds the frame of the window in place.

### WRITEN DESRIPTION OF INVENTION

Slide-Secure is an invention made for preventing an intruder to enter from the outside of a house, apartment or other dwelling from a patio like area. Or back entrance. The description of the invention is a two piece hard plastic sliding unit fitted so it fits grooved together then up against a sliding glass or sliding entry way. The unit also fits up in the frame of the glass or in other models up against the frame as a whole. Then the slide-secure fits in the inter frame of the side of the locking side to furter support to hold it in place to keep the intruder from entering through the sliding door area. The unit slide-secure is holed meaning there is a long hovelled hole for the bolts to fit through then, once the unit is installed tightly the lock washers and wing nuts can be tightens. This makes it all happen for the unit as a whole to lock down the sliding glass entry way or the sliding entry way whichever the consumer has to he secured. This ideas concept is that it works and fits in all apartment complexes sliding glass doors because; they are installed different than residence house sliding glass doors.

### DESCRIPTIONS OF THE VIEWS OF THE DRAWINGS

FIG. 1 Front View:

This is showing “slide-Secure” as a one piece with measurements.

Fitting in the average sliding glass door threshold.

FIG. 2 Front Views:

These views or two parts showing the rear slider that fits against the frame of the door and in the glass Paine too. Note: this part can be turned around and then is applicable to all sliding glass doors. Note: this part on the back where the blots go in is channeled and grooved to allow for the countersinking of the bolt heads.

FIG. 3 Top Views:

This shows the 2 parts having grooves and channel notches at the end allowing the fitting into the frame channel.

FIG. 4 Bottom View:

This view shows the groove in the primary part and the separation causing a groove between the second parts that bolts to it.

FIG. 5 End Views:

Shows the groove that allows the device to lay flat in the doorways threshold when locked in place.

FIG. 6 End View:

Shows the ends of both pieces pointing out the part that holds in the frame of Paine of glass frame.

FIG. 7 Top end View:

This shows how the both ends of the parts fit in the channel of the frame.

FIG. 8 Rear slide View:

This shows the features of the channel of space for the bolts to be adjusted. It shows the extent ion of part that fits in the channel of frame going vertical of threshold. Shows the extent ion that fits up against the Paine of glass or in some doors the bottom of door.

FIG. 9 Front Views:

This is the blocker. It fit up against the fixed door. In some types it would be also on a groove against the fixed door.

FIG. 10 Parts view:

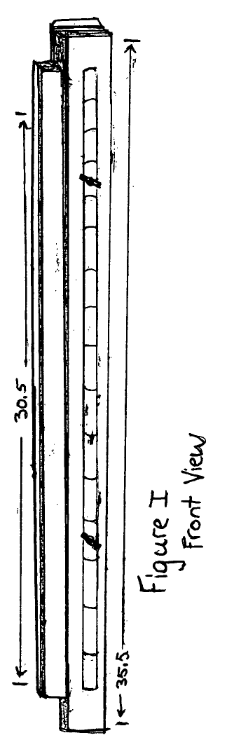

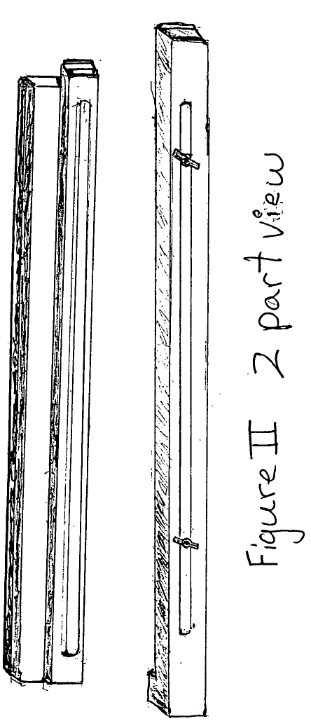

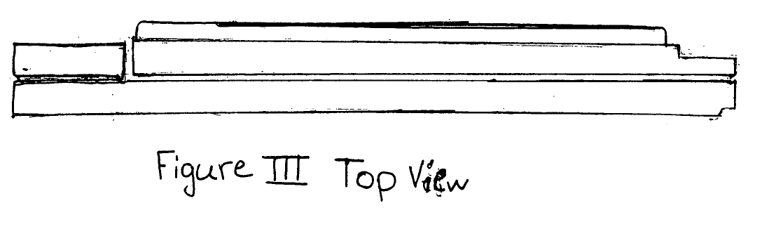

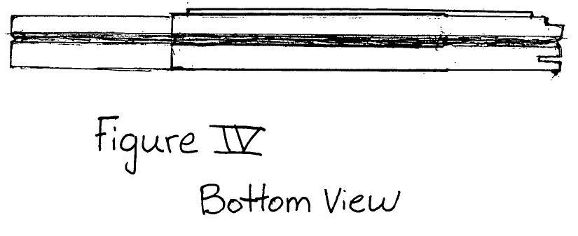

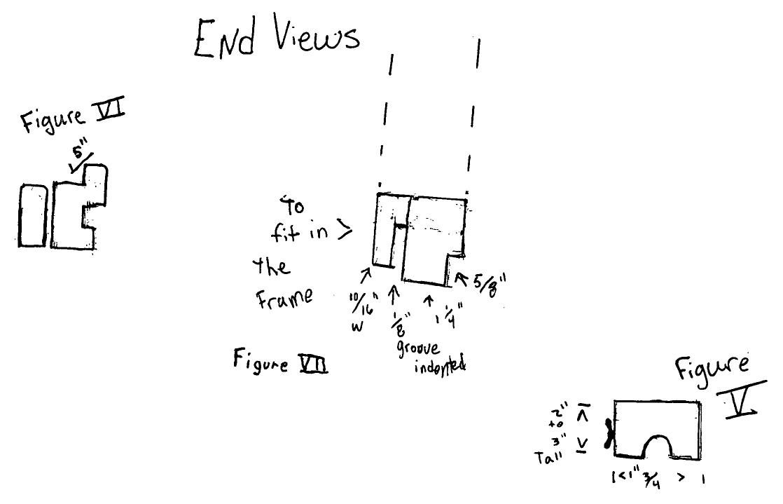

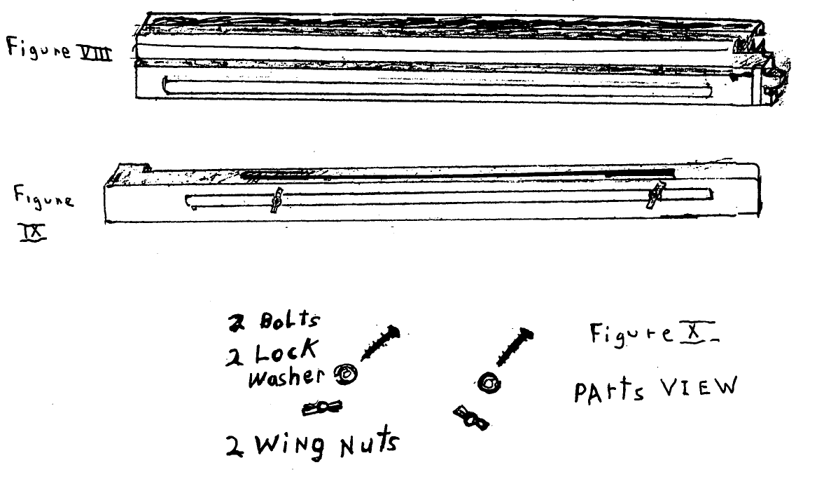

This shows 2 lock washers ¼ in. in size, 2 wing nuts ¼ in. in size, and 2 bolts ¼ in. by 2.5 in. Long.

### DETAILED DESCRIPTION OF INVENTION

Slide-Secure

A. Slide secure is made of high impact plastic but, can be made of other material such as aluminum or light metal.

B. It has 2 sliding parts made with a mold-injection process designed to fit in the grooves of any sliding glass door. This means in the frame and on the groove of the frame. Thus also allowing the part to come apart and be turned another direction making it fit to all sliding glass doors.

C. It has 2 bolts ¼×2½ with 2 washers and 2 wing nuts.

D. The front part of the slider is measured as follows: 35.5 in by ¾ in. wide and 2 in. high, locking end is notched to fit in frame an ½ back side to glass and but end to other door is 1 in. wide but on the side toward the locking door is cut back at 5 in 3/4 on an in. deep to give the back part a stop. This part also is fitted solid with panels of separation slide ½ in up to allow for the back part that fits up against the door slider and glass part. Now this part has holes in to allow the 2 bolts to go through locking the device.

E. The back part which is the fitted part to hold up in the glass frame on most models and can be turned around operate to fit all other models is 30½ in on top of glass frame section and ⅜ in wide that is solid whole piece of the whole part which is 30⅕ in. in ¾ in. high to molded section that fit in window frame. This is also tapered at 1 in to fit in the window frame area. This middle section of his part has 2 holes for the bolts to go through counter sunk in a slider hold allowing for adjustments to fit tight in the frames locking the door up against it and to the window and to threshold of the frame also.

1: The invention and idea Slide-Secure can be made with hard plastic through a mold injection process in various colors.

2: The invention and Idea can do this function by the means of this, on some non commercial sliding glass doors “slide-Secure” can be taken apart or when installed simply put the inside slide lock around opposite; therefore securing the sliding glass door below the glass pane level.
